(19) United States
(12) Patent Application Publication
(10) Pub. No.: US 2010/0080980 A1
(43) Pub. Date: Apr. 1, 2010

(54) MOLDING PROCESS FOR CORE-CONTAINING COMPOSITES AND COMPOSITES FORMED THEREBY

(75) Inventors: Mahendra Maheshwari, Bel Air, MD (US); James J. Velten, Baltimore, MD (US); Steven Davies, Bel Air, MD (US)

Correspondence Address: HARTMAN AND HARTMAN, P.C., 552 EAST 700 NORTH, VALPARAISO, IN, 46383, US

(73) Assignee: MRA SYSTEMS, INC., Baltimore, MD (US)

(21) Appl. No.: 12/241,540

(22) Filed: Sep. 30, 2008

(51) Int. Cl. B32B 3/26; C09J 5/00

(52) U.S. Cl. 428/320.2; 156/305

(57) ABSTRACT

A process for producing composite structures having a core between resin-impregnated composite layers, and composite structures formed by such a process. The process uses non-impregnated fabric layers and a core layer placed on a mold such that the core layer is between at least two fabric layers, a first of which is disposed between the mold surface and a first surface of the core layer, and a second of which is disposed at a second surface of the core layer. The second fabric layer is then infused with a resin, which flows through holes in the core layer into the first fabric layer, such that the first and second fabric layers are uniformly impregnated with the resin and the core layer is not. The resin is then cured to cause the impregnated first and second fabric layers to bond to the core layer.

### BACKGROUND OF THE INVENTION

The present invention generally relates to molding processes for producing composite articles. More particularly, this invention relates to a molding process for producing a composite structure comprising a core between resin-impregnated layers.

A typical construction used in aircraft engine nacelle components (for example, the engine inlet, thrust reversers, core cowl, and transcowl) and other aerostructures (including acoustic panels) is a sandwich-type layered structure comprising a core material between thin top and bottom composite layers or skins. The core material is typically a lightweight material, often a foam or honeycomb polymeric material. A notable example of the latter is an aramid fiber commercially available under the name NOMEX® from DuPonte. A variety of materials can be used for the composite layers, with common materials including a fabric material (for example, a graphite fabric) impregnated with resin (for example, an epoxy resin). A conventional process for producing these layered structures is to separately produce the composite skins by impregnating the fabric with the resin and precuring the impregnated skins. The pre-impregnated skins are then bonded to the core material under pressure and heat, typically performed in an autoclave, during which additional curing occurs. Disadvantages associated with this process include long cycle times, high capital investment, and difficulty when attempting to implement for complex geometries.

Alternative processes for producing layered composite structures do not employ curing in an autoclave. Examples include resin transfer molding (RTM) and vacuum-assisted resin transfer molding (VARTM). However, such processes are typically performed on fabric materials that do not contain a lightweight core material, and are completely impregnated with resin during the RTM/VARTM process to produce a solid composite laminate.

### BRIEF DESCRIPTION OF THE INVENTION

The present invention provides a process for producing composite structures that comprise a core between resin-impregnated composite layers, and composite structures formed by such a process. The invention can be employed to produce aircraft engine nacelle components, including engine inlets, thrust reversers, core cowls, and transcowls, as well as other aerostructures (including acoustic panels) and a variety of other sandwich-type layered structures.

According to a first aspect of the invention, the process includes providing non-impregnated fabric layers and a core layer, the latter of which is provided with a plurality of through-holes to define flow passages between oppositely-disposed first and second surfaces of the core layer. The fabric layers and the core layer are placed on a mold such that the core layer is between at least two fabric layers, a first of the fabric layers is disposed between a surface of the mold and the first surface of the core layer, and a second of the fabric layers is disposed at the second surface of the core layer to yield a non-impregnated stacked structure that conforms to the surface of the mold. The second fabric layer is then infused with a resin, and the core layer and the through-holes therein cause the resin to flow through the through-holes and into the first fabric layer such that the first and second fabric layers are uniformly impregnated with the resin, but the core layer is not. The resin is then cured to not only produce resin-impregnated composite layers on either side of the core layer, but also bond the impregnated composite layers to the core layer.

A second aspect of the invention is the composite structures formed by the above process, characterized by the through-holes in the core layer being filled with the cured resin, whereas the remainder of the core layer is essentially free of the resin.

Significant advantages of this invention include the potential for shorter cycle times and significantly reduced capital equipment investment, including the ability to perform the curing process without an autoclave, and the use of lower curing temperatures that allow the use of lower-cost tooling. The process also allows for the use of relatively lower-cost materials to produce the composite structures, and the ability to adapt the process to produce composite structures with relatively complex geometries.

Other objects and advantages of this invention will be better appreciated from the following detailed description.

### BRIEF DESCRIPTION OF THE DRAWINGS

FIG. 1 is a perspective view of a fan cowl of a type used for an aircraft engine nacelle.

FIGS. 2 and 3 schematically represent composite structures laid-up prior to an infusion step, with each composite structure comprising a core layer between multiple non-impregnated fabric layers in accordance with first and second embodiments of this invention.

FIG. 4 schematically represents an exploded view of the composite structure of either FIG. 2 or 3, and a mold on which the composite structure is placed to mold one-half of the fan cowl of FIG. 1.

FIG. 5 represents processing steps performed to produce the composite structures of FIGS. 2 and 3.

FIGS. 6 and 7 are scanned images of composite structures produced in accordance with the laid-up layers of FIGS. 2 and 3, respectively.

FIGS. 8 and 9 are scanned images of composite structures produced in accordance with the laid-up layers of FIGS. 2 and 3, respectively, showing in detail resin-filled through-holes within the core layers of the composite structures.

### DETAILED DESCRIPTION OF THE INVENTION

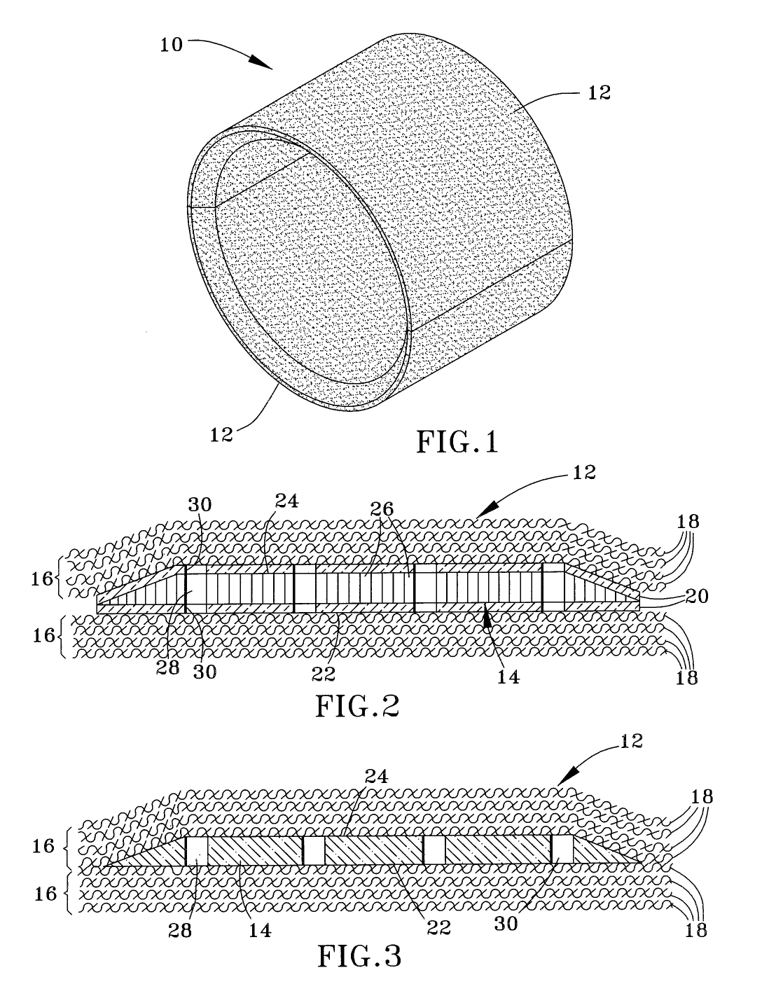

FIG. 1 is representative of an aircraft engine nacelle 10 that has two engine inlet (fan) cowls 12 that can be produced using processing steps of the present invention. The fan cowls 12 have a composite structure that includes a core layer between a pair of outer skins. While the invention will be described in reference to the fan cowls 12, it should be understood that the invention is applicable to a variety of components that benefit from having a composite structure, including but not limited to other aircraft engine nacelle components (for example, thrust reversers, core cowls, and transcowls) and other aerostructures (for example, acoustic panels).

FIGS. 2 and 3 represent two embodiments for constructing the fan cowls 12 of FIG. 1. In each embodiment, a core layer 14 is disposed between stacks 16 of fabric layers 18. The embodiment of FIG. 2 further includes a film 20 between the surfaces 22 and 24 of the core layer 14 and each stack 16 of fabric layers 18, whereas the films 20 are optional in the embodiment of FIG. 3 as a result of the core layer 14 of FIG. 3 being a different material. In particular, the core layer 14 of FIG. 2 is constructed of an open-cell or otherwise porous material with continuous passages 26 passing entirely through the core layer 14. A nonlimiting example of this type of core material is a honeycomb-type material, such as a honeycomb material formed of the aforementioned NOMEX® aramid fibers. Such core materials are well known in the art, and therefore will be discussed in any detail. It should suffice to say that the passages 26 typically have a hexagonal cross-sectional shape with a typical cell width of about three to about ten millimeters, though lesser and greater widths are also foreseeable. In contrast, the core layer 14 of FIG. 3 is constructed of a closed-cell or otherwise nonporous material that lacks the continuous passages 26 of FIG. 2, and is essentially impermeable to, for example, a resin that will be used to infiltrate the fabric stacks 16 as discussed below. A nonlimiting example of this type of core material is a closed-cell, low-density, rigid foam material formed of polymethacrylimide and commercially available under the name ROHACELL® from Evonik Industries (formerly Degussa). Yet another nonporous material suitable for the core layer 14 is wood or another cellulosic material, and particularly notable example of which is balsa wood. These core materials are also well known in the art, and therefore will not be discussed in any detail. The thickness of the core layer 14 will depend on the particular application of the composite structure being produced. In the case of the fan cowls 12 of FIG. 1, a typical thickness is about twelve to about twenty-five millimeters, though much lesser and greater thicknesses are foreseeable.

In the condition represented in FIGS. 2 and 3, the fabric stacks 16 and layers 18 are not pre-impregnated with a resin, and as such may be referred to as “dry” fabrics. The fabric layers 18 can be formed of variety of materials, nonlimiting examples of which include fabrics formed of graphite, glass, polymer (e.g., Kevlar®), and ceramic (e.g., Nextel®) fibers. As with the core layer 14, suitable individual thicknesses of the fabric layers 18 and combined thicknesses of the fabric layers 18 to form the fabric stack 16 will depend on the particular application of the composite structure being produced. In the case of the fan cowls 12 of FIG. 1, a typical individual thickness for each fabric layer 18 is about 0.2 to about 0.4 millimeters, and a typical thickness for each fabric stack 16 is about 1.3 to about 2.5 millimeters, though much lesser and greater thicknesses are also foreseeable.

The films 20 of FIG. 2 can be formed of a variety of materials that are capable of being impermeable to the resin later used to infiltrate the composite structure formed by the core layer 14 and fabric layers 18, and particularly the fabric stacks 16 of the composite structure. Suitable materials for the films 20 are compositionally compatible with the materials that form the core layer 14 and fabric layers 18, meaning that the materials of the core layer 14, fabric layers 18, films 20 and resin do not undergo reactions that would be adverse to the structural integrity of the composite structure to the extent that the composite structure is unacceptable for its intended purpose. Particularly suitable materials for the films 20 include encapsulated and film adhesive materials capable of adhering to the core layer 14, nonlimiting examples of which include impermeable fiberglass and film adhesive materials that may be precured with the core layer 14. Also suitable are other types of impermeable sheet materials capable of bonding to the core layer 14 when adequately heated. As with the other layers of the composite structure, the thickness of each film 20 may depend on the particular application of the composite structure being produced. In additional, suitable thicknesses will depend on the material of the films 20 and whether the films 20 are capable of contributing to the structural integrity of the composite structure. Generally, a suitable thickness is believed to be about 0.1 to about 0.2 millimeters, though lesser and greater thicknesses are foreseeable.

According to a particular aspect of the invention, the core layers 14 of FIGS. 2 and 3 are provided with through-holes 28 by drilling or any other suitable technique capable of forming the holes 28 of sufficient size and geometry to enable resin to flow through the core layer 14, thereby enabling one of the fabric stacks 16 to be impregnated with resin introduced by resin infusion into the other fabric stack 16. For example, in FIGS. 2 and 3 a liquid resin can be introduced at the upper fabric stack 16 (as viewed in these Figures), caused to flow through the through-holes 28 in the core layer 14, and into the lower fabric stack 16. The through-holes 28 enable both fabric stacks 16 to be infiltrated and impregnated with the resin without also infiltrating and impregnating the core layer 14. In FIG. 2, the films 20 prevent or at least substantially eliminate the flow of resin through the passages 26 in the core layer 14, and have through-holes 30 aligned with the through-holes 28 of the core layer 14, such that the holes 28 and 30 define continuous passages between the fabric stacks 16 at the opposite surfaces 22 and 24 of the core layer 14. In FIG. 3, the films 20 are unnecessary because the nonporous construction of the core layer 14 prevents the flow of resin through the core layer 14, other than through the through-holes 28 of the core layer 14. Suitable diameters and spacings for the through-holes 28 and 30 will depend on the particular resin used to infiltrate the composite structure, including its viscosity and other flow characteristics through the fabric layers 18. In practice, diameters of one-quarter inch (about six millimeters) have been effective when located with center-to-center spacings of about two inches (about five centimeters).

A wide variety of polymeric materials can be chosen as the resin used to infiltrate the composite structures of FIGS. 2 and 3. The principle role of the resin is to infiltrate the fabric layers 18 and form a matrix material for the fibrous material used to form the fabric layers 18, and as such the resin contributes to the structural strength and other physical properties of the fabric layers 18, as well as the entire composite structure as a whole. Therefore, the resin should be compositionally compatible with the fabric layers 18. Additionally, because the resin will contact at least the walls of the through-holes 28 in the core layer 14, the resin must also be compositionally compatible with the materials that form the core layer 14 and, if present, the films 20. The resin must also be capable of curing under temperature conditions that will not thermally degrade or otherwise be adverse to the materials of the core layer 14, fabric layers 18, and films 20. On this basis, particularly suitable resins materials are believed to include epoxies, with curing temperatures typically below 200° C., for example, about 190° C.

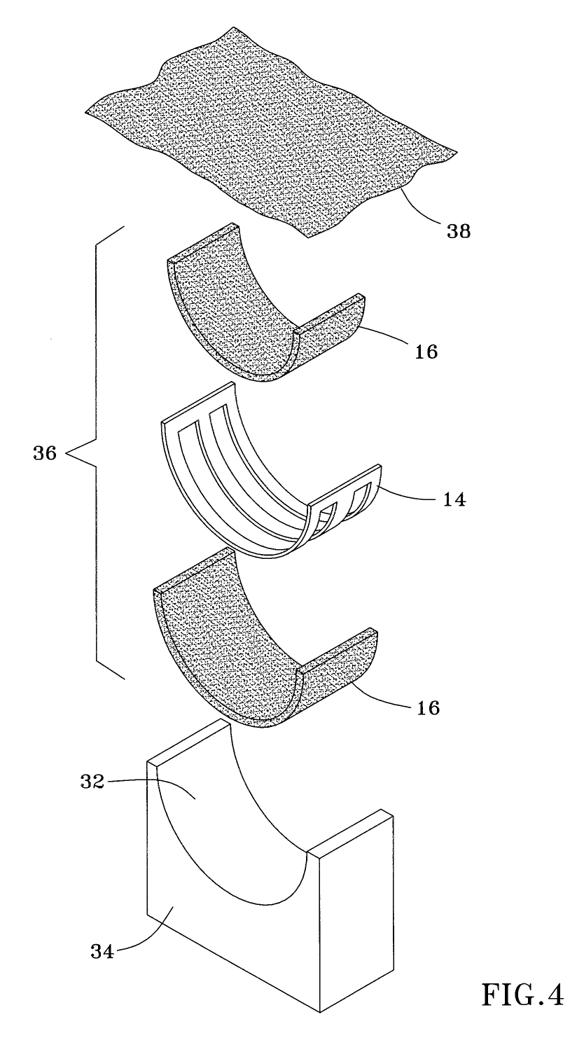

FIG. 4 schematically represents an arrangement of the core layer 14 and two fabric stacks 16 on a mold cavity surface 32 of a mold 34 suitable for producing one of the cowls 12 of FIG. 1. When placed on the mold 34, the core layer 14 and fabric stacks 16 yield a non-impregnated (dry) stacked structure 36 that conforms to the surface 32 of the mold 34. Other possible structural components of the molding system will depend on the technique used to resin-infiltrate the fabric stacks 16 and cure the resulting resin-impregnated stacked structure. For example, if a vacuum-assisted resin transfer molding (VARTM) method is used, the stacked structure 36 is covered by a bag 38 to enable a vacuum to be drawn between the mold cavity surface 32 and the bag 38, such that the bag 38 is able to compress the layers 14 and 16 of the stacked structure 36 and draw resin through the stacked structure 36, for example, by applying the resin to the upper surface of the upper fabric stack 16, and then drawing the resin through the through-holes 28 (and optionally 30) into the lower fabric stack 16 adjacent the mold 34. A bag 38 can similarly be used in an autoclave process, by which pressure is applied to the upper surface of the bag 38, such that the bag 38 compresses the layers 14 and 16 of the stacked structure 36 and promotes the flow of resin from the surface of the upper fabric stack 16, through the through-holes 28 (and optionally 30), and into the lower fabric stack 16. Once the resin has thoroughly infiltrated the fabric layers 18, the resulting resin-impregnated stacked structure can be heated to a temperature and for a duration sufficient to cure the resin. The infiltration/impregnation and curing temperatures, pressure/vacuum levels, and other parameters of the infiltration and curing cycles will depend on the particular materials used, and can be determined by routine experimentation.

In view of the above, it can be appreciated that the fabric layers 18 are infiltrated and bonded to the core layer 14 in essentially a single step, instead of being pre-impregnated with a resin, placed on the core layer 14, and then bonded to the core layer 14 in three entirely discrete steps. Furthermore, in the embodiment represented in FIG. 2, the process infiltrates the lower fabric stack 16 without infiltrating the passages 26 within the core layer 14. Therefore, the resin does not unnecessarily increase the weight of the core layer 14 beyond the weight attributed to the limited amount of resin within the through-holes 28.

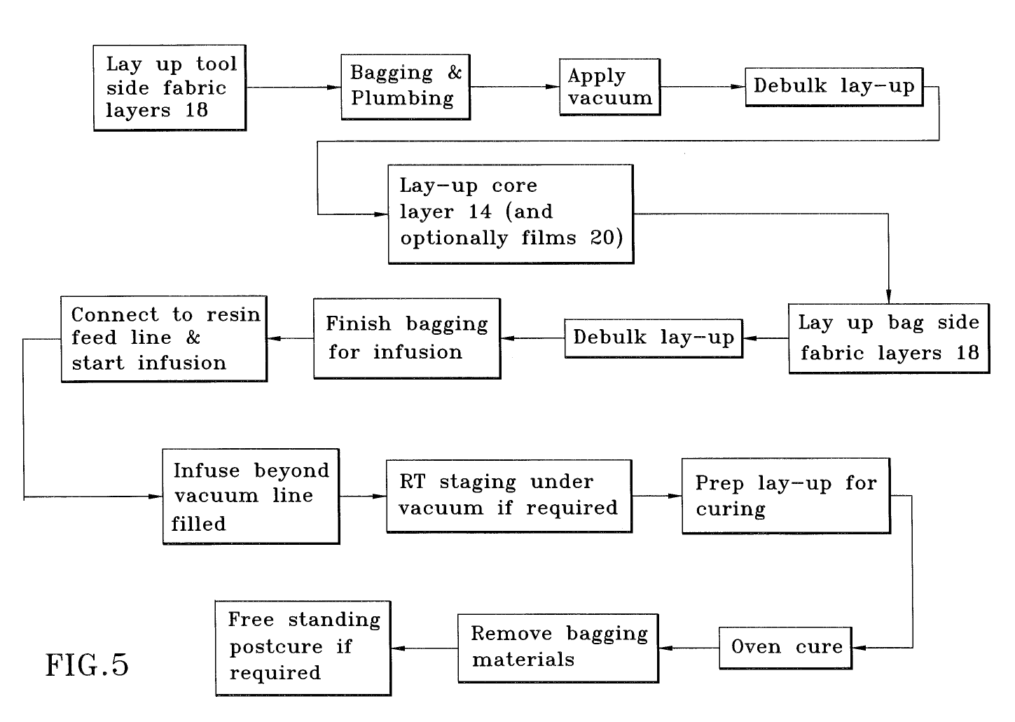

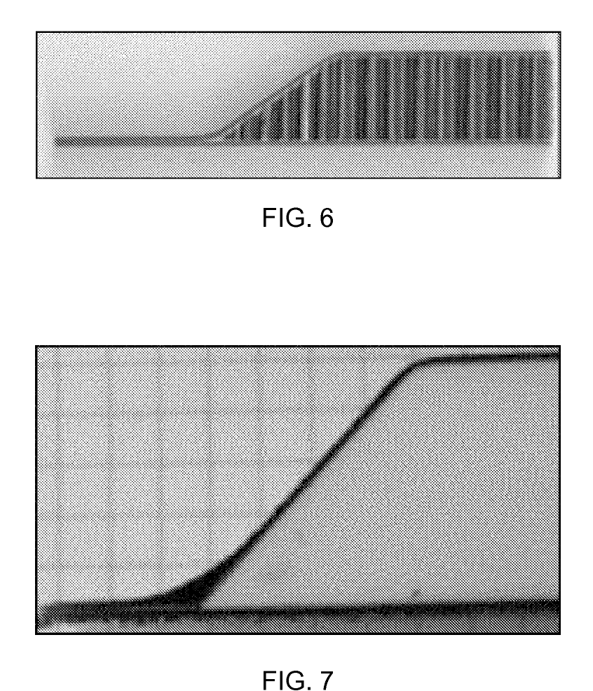

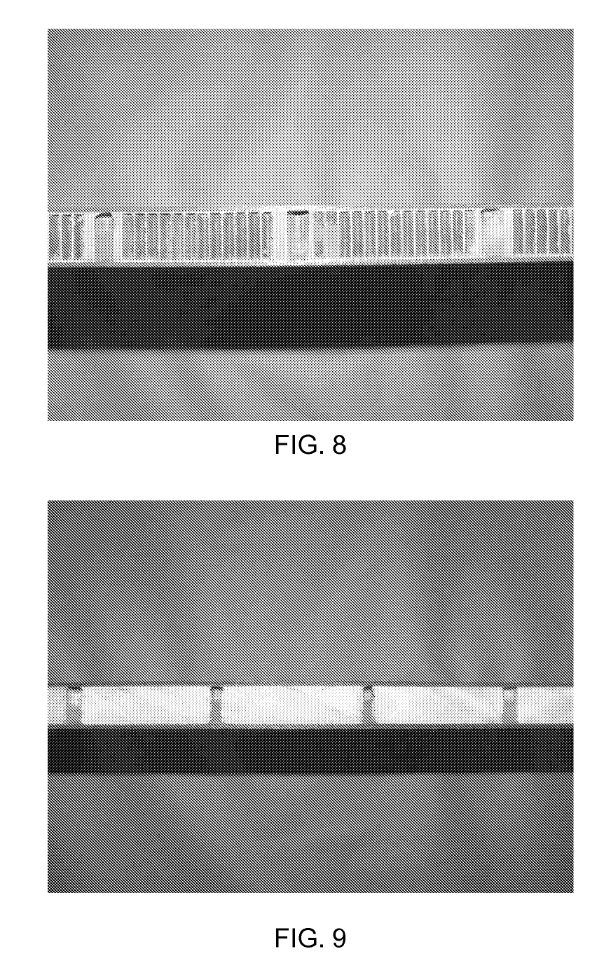

FIG. 5 is a flow chart more particularly identifying individual steps performed when employing a VARTM technique to produce the composite structures of FIGS. 2 and 3. FIGS. 6 and 7 are scanned images showing cross-sections near the edges of full-scale cowls of the type shown in FIG. 1 and produced in accordance with the composite structures represented in FIGS. 2 and 3, respectively. As seen in FIG. 6, none of the honeycomb passages within the core layer are filled with resin. FIGS. 8 and 9 are scanned images showing regions of the cowls of FIGS. 6 and 7, respectively, containing through-holes 28 filled with the resin. The constructions of the cowls, in which a core layer is sandwiched between much thinner top and bottom composite skins, is typical of aerostructures and engine nacelle components such as the engine inlet, thrust reversers, core cowl, transcowl, etc. As evident from FIGS. 6 through 9, each of the processes represented in FIGS. 2 and 3 produced a high-quality laminate and bonded structure, while having the additional advantages of significantly reduced cycle time and cost.

While the invention has been described in terms of specific embodiments, it is apparent that other forms could be adopted by one skilled in the art. For example, the physical configuration of the composite structures, both before and after resin infiltration, could differ from that shown, and materials and processes other than those noted could be used. Therefore, the scope of the invention is to be limited only by the following claims.

1. A process of producing a composite structure comprising a core between resin-impregnated composite layers, the process comprising:
providing non-impregnated fabric layers and a core layer;
providing a plurality of through-holes in the core layer to define flow passages between oppositely-disposed first and second surfaces of the core layer;
placing at least two of the fabric layers and the core layer on a mold such that the core layer is between the two fabric layers, a first of the at least two fabric layers is disposed between a surface of the mold and the first surface of the core layer, and a second of the at least two fabric layers is disposed at the second surface of the core layer to yield a non-impregnated stacked structure that conforms to the surface of the mold;
infusing the second fabric layer with a resin, the core layer and the through-holes therein causing the resin to flow through the through-holes and into the first fabric layer such that the first and second fabric layers are uniformly impregnated with the resin and the core layer is not; and then
curing the resin to cause the impregnated first and second fabric layers to bond to the core layer.

2. The process according to claim 1, wherein the core layer comprises a porous material with continuous passages interconnecting the first and second surfaces of the core layer, and the process further comprises applying resin-impermeable first and second films to the first and second surfaces of the core layer, respectively, and forming through-holes in the first and second films, wherein the resin flows through the through-holes in the first film, then through the through-holes in the core layer, and then through the through-holes in the second film during the infusing step, and the resin does not flow through the continuous passages within the core layer.

3. The process according to claim 2, wherein the porous material of the core layer comprises a honeycomb material and the continuous passages thereof are honeycomb passages.

4. The composite structure produced by the process of claim 2, wherein the through-holes in the core layer are filled with the cured resin and the remainder of the core layer is essentially free of the cured resin.

5. The process according to claim 1, wherein the core layer comprises a closed-cell foam material without continuous passages interconnecting the first and second surfaces of the core layer, and the closed-cell foam material restricts the flow of the resin through the core layer to the through-holes therein.

6. The composite structure produced by the process of claim 5, wherein the through-holes in the core layer are filled with the cured resin and the remainder of the core layer is essentially free of the cured resin.

7. The process according to claim 1, wherein the core layer is a polymeric material.

8. The process according to claim 1, wherein the core layer is a metallic material.

9. The process according to claim 1, wherein the core layer is a cellulosic material.

10. The process according to claim 1, wherein the non-impregnated fabric layers comprise at least one of graphite, glass, polymer and ceramic fibers.

11. The process according to claim 1, wherein the at least two fabric layers have a combined thickness less than the core layer.

12. The process according to claim 1, wherein the core layer is placed between more than two of the fabric layers.

13. The process according to claim 1, wherein the curing step is performed under pressure and at an elevated temperature.

14. The process according to claim 1, wherein the curing step is performed under vacuum and at an elevated temperature.

15. The process according to claim 1, wherein the composite structure is a component of an aircraft nacelle.

16. The component produced by the process of claim 15, wherein the through-holes in the core layer are filled with the cured resin and the remainder of the core layer is essentially free of the cured resin.

17. A process of producing an aircraft nacelle component having a composite structure comprising a core between resin-impregnated composite layers, the process comprising:
providing non-impregnated fabric layers and a core layer;
providing a plurality of through-holes in the core layer to define flow passages between oppositely-disposed first and second surfaces of the core layer;
placing the fabric layers and the core layer on a mold such that the core layer is between the fabric layers, at least two of the fabric layers are disposed between a surface of the mold and the first surface of the core layer, and at least two of the fabric layers are disposed at the second surface of the core layer to yield a non-impregnated stacked structure that conforms to the surface of the mold, the fabric layers having a combined thickness less than the core layer;
infusing the at least two fabric layers disposed at the second surface of the core layer with a resin, the core layer and the through-holes therein causing the resin to flow through the through-holes and into the at least two fabric layers disposed at the first surface of the core layer such that the fabric layers are uniformly impregnated with the resin and the core layer is not; and then
curing the resin to cause the impregnated fabric layers to bond to the core layer, wherein the through-holes in the core layer are filled with the cured resin and the remainder of the core layer is essentially free of the cured resin.

18. The process according to claim 17, wherein the core layer comprises a porous material with continuous passages interconnecting the first and second surfaces of the core layer, the process further comprising applying resin-impermeable first and second films to the first and second surfaces of the core layer, respectively, and forming through-holes in the first and second films, wherein the resin flows through the through-holes in the first film, then through the through-holes in the core layer, and then through the through-holes in the second film during the infusing step, and the resin does not flow through the continuous passages within the core layer.

19. The process according to claim 17, wherein the core layer comprises a closed-cell foam material without continuous passages interconnecting the first and second surfaces of the core layer, and the closed-cell foam material restricts the flow of the resin through the core layer to the through-holes therein.

20. The component produced by the process of claim 17.
